(19) United States
(12) Patent Application Publication
(10) Pub. No.: US 2017/0057356 A1
(43) Pub. Date: Mar. 2, 2017

(54) SEAMLESS INSTRUMENT CLUSTER

(71) Applicants: James Frederick Krier, Grosse Pointe Woods, MI (US); Paul Fredrick Luther Weindorf, Novi, MI (US); Carl Richard Evans, Chelmsford (GB)

(72) Inventors: James Frederick Krier, Grosse Pointe Woods, MI (US); Paul Fredrick Luther Weindorf, Novi, MI (US); Carl Richard Evans, Chelmsford (GB)

(21) Appl. No.: 14/837,553

(22) Filed: Aug. 27, 2015

(51) Int. Cl. B60K 35/00; G02B 5/20; G02B 1/118

(52) U.S. Cl. CPC B60K 35/00; G02B 1/118; G02B 5/205

(57) ABSTRACT

A seamless instrument cluster is provided herein, and a method for providing a seamless instrument cluster as well. The seamless instrument cluster includes an antireflective (AR) film. The AR films may be provided with an airgap disposed between. Also discussed herein is providing an instrument cluster with an applique with a fade pattern. The aspects disclosed herein may be implemented with an instrument cluster employing a neutral density (ND) filter situated between an antiglare surface on a front layer of the applique and a rear layer of an ink.

### BACKGROUND

Display assemblies provide information to a viewer through various techniques. In certain traditional implementations, the display assemblies were primarily mechanical, and provided information via mechanical gauges, pointers, and the like.

A common implementation of display assemblies are vehicle instrument clusters. The digital assemblies interact with a central processor, for example an electronic control unit (ECU), receive information, and provide an indication based on the received information. The received information may be related to information about the operation of the vehicle, for example, the speed, fuel levels, revolutions-per-minute (RPM), or the like.

In recent times, mechanical implementations of the displays have been supplemented or replaced by digital displays. In the field of vehicle instrument clusters, digital displays may be implemented along with non-digital layers, such as appliques, plastic cases, and the like. The digital displays may be implemented with a variety of electronic techniques, such as thin-film transitors (TFT), liquid crystal displays (LCD), and organic light emitter displays (OLED), and the like.

These digital displays may be implemented with a variety of apertures and openings. An applique may be placed over the digital display, fashioned with a variety of openings, with the openings capable of showing digital information from a single or plurality of digital displays placed behind the applique.

Various implementers have attempted to create an environment which appears seamless. The seamless environment attempts to minimize the appearance of multiple layers (including an applique, a variety of films, and the like), thus creating a continuous look.

On the contrary, the seamless environment or look appears to a viewer as if the viewer is viewing one continuous surface. Thus, the discontinuous look of implementing multiple layers is obviated or significantly lessened.

FIGS. 1(a)-(c) illustrate an example of a seamless instrument cluster 100 according to a prior art implementation. Referring to FIG. 1(a), an instrument cluster 100 is shown. The instrument cluster is installed in a vehicular context or environment. The instrument cluster 100 includes various indicia 101, various mechanical pointers 102, and an area 103 for digital presentation of additional information.

FIG. 1(b) illustrates an example of the area 103. In FIG. 1(b), the area 103 includes various lighted indicia 104. The lighted indicia 104 may be sourced from a light emitting diode (LED) disposed above the display 140. The LEDs provide backlighting for the indicia 104.

FIG. 1(c) illustrates an example of instrument cluster 100 with a variety of layers shown in a deconstructed fashion. As shown, a back panel 140 with a TFT display surface 141 is shown. The back panel 140 lights selectively based on received information from an ECU (or central processing unit). The light is shown through an applique layer 130. The applique layer 130 contains various openings 131 to allow light to selectively go through. Additionally, other apertures 132 may be provided to allow mechanical elements to be displayed as well (such as pointers and the like).

Film layer 120 is provided to augment the seamless look of the instrument cluster 100. One implementation of the film is a Bayer LM296 film with a neutral density transmission factor of 25%. However, even with the use of the Bayer LM296 film (or other similar concepts), the technique is limited in that various effects are still present. For example, in certain lighting conditions, the instrument cluster may still appear not seamless. Another known effect, “sparkle” may become apparent with the use of anti-glare films. Sparkle is caused by the antiglare “rough” surface structure on the top of film layer 120. In conventional implementations, that magnitude or level of the antiglare surface was high, thereby increasing the amount of light reflected back to the eye. However, this did not work as desired, because the feature size of the antiglare surface led to sparkles on the order of a pixel pitch dimension. The above implementation may require additional films or coating to address these issues.

### SUMMARY

The following description relates to a seamless instrument cluster. Exemplary embodiments may also be directed to the seamless instrument cluster itself, or methods of manufacturing the seamless instrument cluster.

An instrument cluster is provided herein. The instrument cluster may include a display configured to project light in response to information provided via a digital display renderer; a first antireflective (AR) layer or surface applied onto a surface of the display; an applique layer with an aperture to allow the projected light to a viewer of the instrument cluster; and a second AR film applied to a surface of the applique layer that faces the display.

Another instrument cluster is provided herein. The instrument cluster includes a display configured to project light in response to information provided via a digital display renderer; a fade pattern applied onto a back surface of an applique layer; the applique layer with an aperture to allow the projected light to a viewer of the instrument cluster; and an AR layer or surface applied to a surface of the applique layer that faces the display.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIGS. 1(a)-(c) illustrate an example of a seamless instrument cluster according to a prior art implementation.

FIG. 2 illustrates an example of a side-view of an instrument cluster 200 for providing a seamless implementation.

FIG. 3 illustrates an example of the implementation shown in FIG. 2 with glare and reflections shown.

FIG. 4 illustrates an example of a side-view of an alternate implementation of an instrument cluster without some of the advantages shown in FIGS. 2 and 3.

FIG. 5 illustrates an example of a fade pattern employed with either of the instrument clusters shown in FIGS. 2 and 4.

FIG. 6 illustrates another explanation of the fade patterns according to the instrument clusters shown in FIGS. 2 and 4.

FIG. 7 illustrates a graph of a contrast sensitivity function of eye.

FIGS. 8 and 9 illustrate graphs employed to determine an AG film implemented in both instrument clusters shown in FIG. 2.

FIG. 10 illustrates an example of a method of manufacturing a seamless instrument cluster.

FIGS. 11(a)-(c) illustrate various stages of the structure manufactured according to FIG. 10, and shown in FIG. 2.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the Background section, various instrument cluster implementations incorporate digital displays integrated with appliques and other coverings. However, in these implementations, various discontinuities become apparent. So the viewer of the instrument cluster is very apparent of the fact that multiple layers (a lighting layer, an applique layer, and others) are implemented.

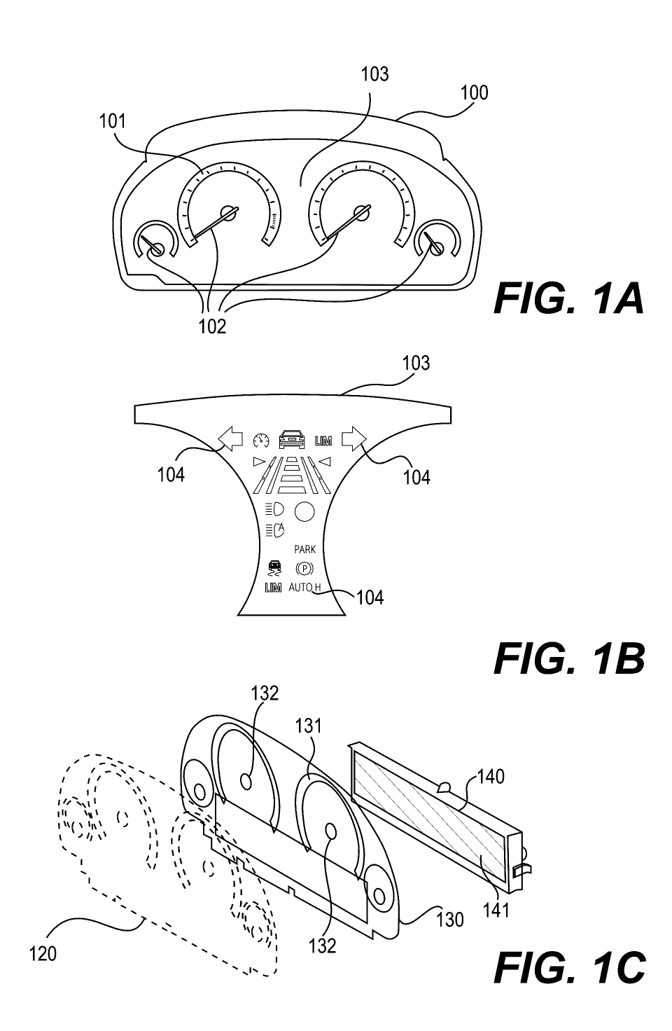

Various attempts, such as those described in FIGS. 1(a)-(c) have been proposed to solve this problem. However, those solutions are not fully effective and produce other problems, such as “sparkles”. Further, implementation of the film (e.g. Bayer LM296) may be extraneous and expensive.

The proposed solution discussed with a variety of embodiments below improve upon the embodiment discussed above by:

1) Improving the black panel effect, i.e. a surface looking black to a viewer in both an on/off state of the display;

2) Reducing overall reflection;

3) Employing a one film solution (rather than implementing multiple films);

4) Improving optical clarity while reducing sparkle; and

5) Implementing air gaps, which obviate the need for optical bonding.

Disclosed herein is an instrument cluster with a seamless presentation, and a method for implementing a seamless instrument cluster. The aspects disclosed herein allow for a seamless presentation, while simplifying implementation and achieving all the advantages enumerated above.

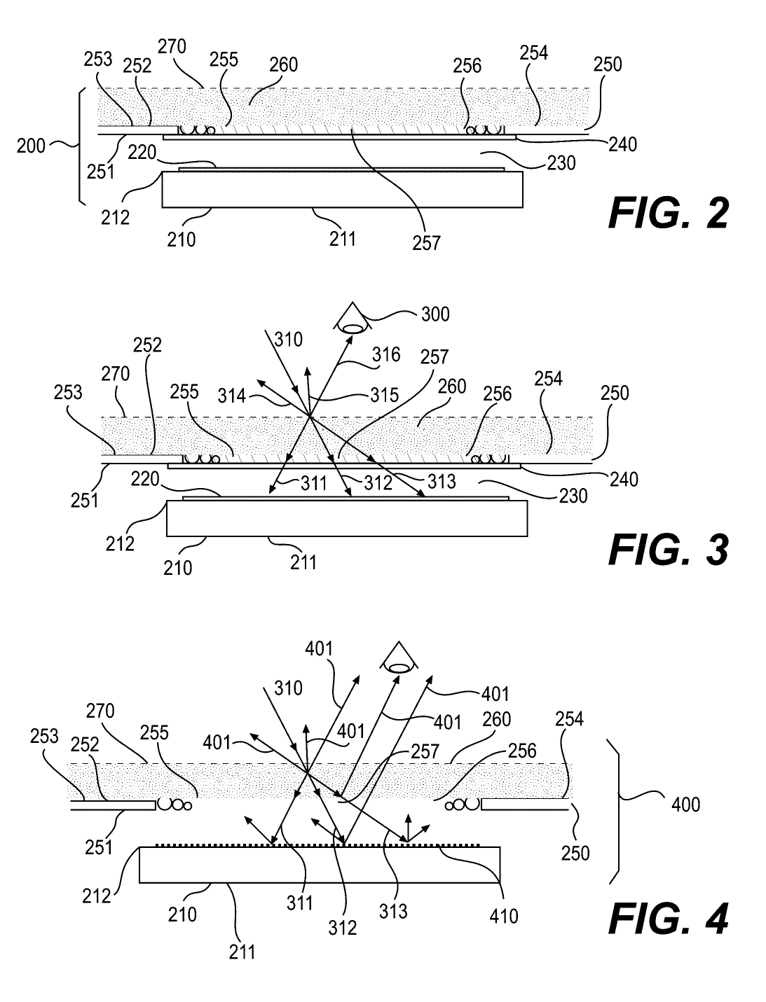

FIG. 2 illustrates an example of a side-view of an instrument cluster 200 for providing a seamless implementation. The instrument cluster 200 may be implemented in a variety of contexts, such as a vehicle. The instrument cluster 200 may be coupled to any sort of ECU that is capable of digitally rendering information via a digital display.

On the bottom, or back of the instrument cluster 200, a digital display 210 is provided. The digital display 210 may be any sort of digital display capable of rendering and transferring information via an instrument cluster 200.

The digital display 210 has a first surface 211 facing the back of the instrument cluster 200. The first surface 211 abuts an area where the instrument cluster 200 is to be installed or implemented. The digital display also includes a second surface 212. The second surface 212 may have an antireflection (AR) film 220. The AR film 220 is of a smooth-type with no antiglare (AG) structure. One such example of a smooth-type that may be implemented with the instrument cluster 200 is a Motheye film. In an example not shown, the AR film 220 may be omitted. This becomes possible because the display 210 provided is of a smooth-type. Thus, employing the aspects disclosed herein, the seamless effect is achieved without providing the AR film 220.

On top of the AR film 220, an air gap 230 is provided. The air gap 230, as shown in FIG. 3, provides a variety of techniques for improving glare, while avoiding some of the deficiencies associated with a technique employing optical bonding.

On the other side of the air gap 230, an AR film 240 is provided on a first surface 251 on an applique layer 250. The applique layer 250 includes a first surface 251 facing the direction of the display 210, and a second surface 252 facing the viewer. The second surface 252 refers to the front side of the ink being viewed.

The applique layer 250 includes a variety of features. On both ends of the applique layer 250 is a first solid inked end 253 and a second solid inked end 254. Also included are a first fade pattern 255 and a second fade pattern 256. In between the fade patterns 255 and 256, is an opening (aperture) 257. The importance of the fade patterns will be described in greater detail below. The aperture 257 may be filled with an optical adhesive (or some sort of optical adhesive system).

The applique layer 250 may be additionally provided with one, some, or all of the following (the applique layer 250 is always a separate layer as any of the enumerated layers/filters/films listed below):

1) a neutral density (ND) filter 260 (shown in FIG. 2);

2) a combination of polarization films and other optically bonded ND filter; and

3) a polarization film.

On the opposite surface of the ND filter 260 (i.e. the viewer side), a antiglare (AG) surface 270 is provided. The AG surface 270 raises the ambient reflected level to a level where it reduces the contrast ratio difference between the opening 257 and the various black printed areas (inked ends 253, 254 and fade patterns 255, 256).

FIG. 3 illustrates an example of instrument cluster 200 with a viewer 300 addressing the instrument cluster 200 with their eyes. Various light 310 (which is refracted to light rays 311-313) when propagated through the various films, layers and other elements is shown. As shown, reflections 314, 315, and 316 are shown. Because of the aspects shown in FIG. 2, the elements behind the antiglare surface 270 do not reflect light back to the viewer 300.

FIG. 4 illustrates a side-view of an implementation of an instrument cluster 400 not employing a smooth AR film (as shown instrument cluster 200). FIG. 4 illustrates that without implementing a smooth AR film (shown by rough AG surface 410), that light 401 is scattered back to the viewer 300, thereby making the display area more visible.

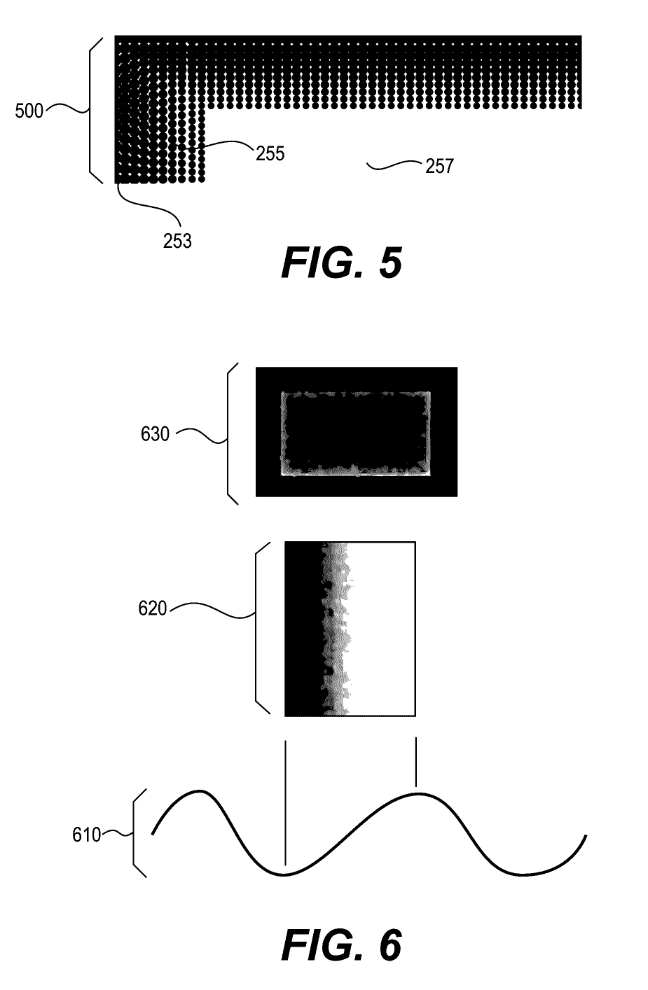

FIG. 5 illustrates an example of a fade pattern 500, such as a first fade pattern 255 and the second fade patterns 256 described and shown above. The fade pattern 500 is shown in a manner that is sinusoidal in fashion. The sinusoidal pattern aids in the aspects disclosed herein. Other dot patterns, such as a randomized dot pattern may also be implemented.

FIG. 6 illustrates a fade pattern according to the aspects disclosed herein. As shown, the transition from a solid inked area (for example, solid portions 253 and 254) to a fade pattern (for example, fade patterns 255 and 256) is illustrated. In the specific pattern 600 shown, a transition or the amount of transmission employed for the ink application is applied in a sinusoidal fashion 610. The actual application is shown in example 630, with an enlarged portion shown in example 620. Depending on the portion of the sinusoidal wave 610, the darkness or transmission is varied (as shown in 620). This implementation is known as a half-sinusoidal application, as the half a sinusoidal period is employed to vary the fade pattern from black to a lesser transmission of black. At the peak of the wave, no more ink is applied.

The lowest sinusoidal spatial frequency works best due to the contrast sensitivity characteristics per the Contrast Sensitivity Function (CSF) of the human eye; however, the tradeoff is the amount of intrusion into the active area of the display. The sinusoidal fade pattern may be developed by several means. The two tone pattern shown in FIG. 5 is manufactured by screen printing methods utilized for applique printing.

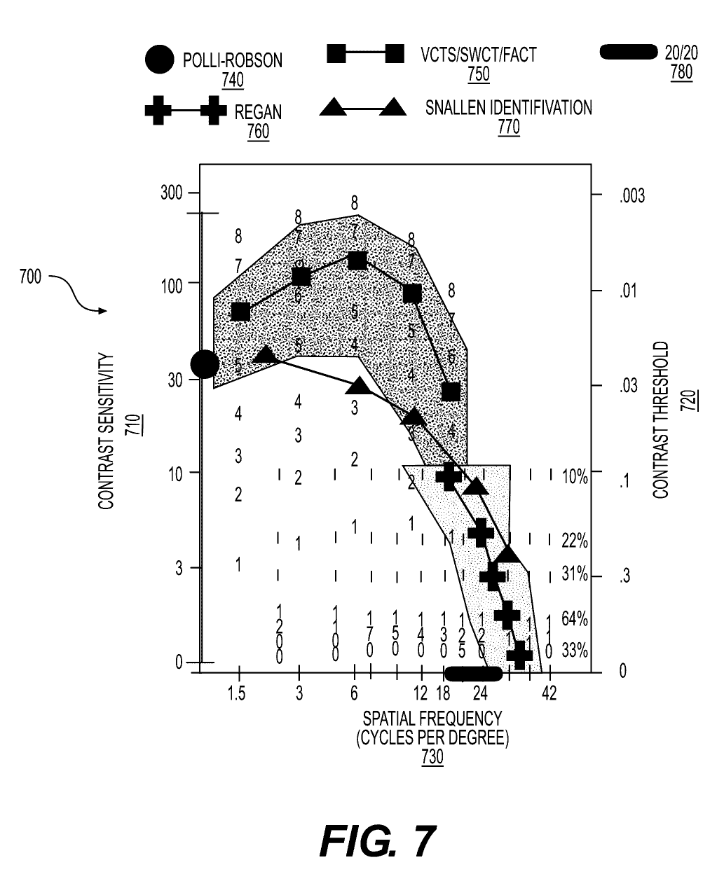

FIG. 7 illustrates a graph 700 of a contrast sensitivity function of eye. The graph 700 explains why certain spatial frequency ranges are less visible to the eye and therefore may be used to hide the border via the fade pattern utilizing a frequency that is less visible. The y-axis 710 is the contrast sensitivity 710 (and contrast threshold 720). The x-axis 730 is the spatial frequency (in cycles per degree). As shown, various known relationships are plotted, including the Pelli-Robson 740, the VCTS/SWCT/FACT 750, Regan 760, Snellen identification 770, and 20/20 780. These methods are generally known, and thus, an explanation will not be further delved into.

The graph 700 explains that spatial frequencies below 6 cycles per degree have a lower contrast sensitivity (i.e., are harder to see contrasts). Thus, the fade patterns (as will be explained in further detail below), allow for these lower contrast sensitivities to be achieved.

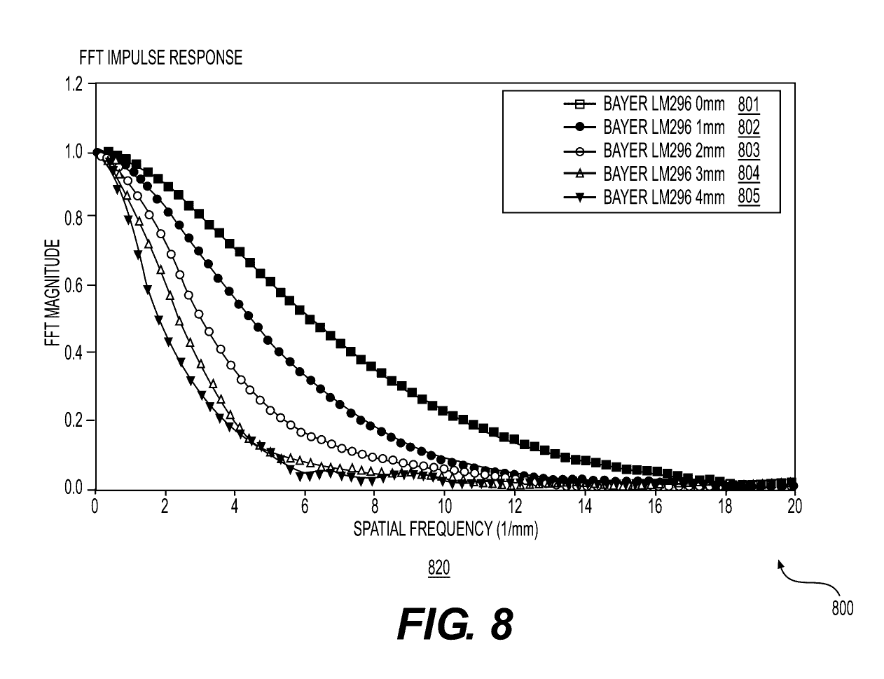

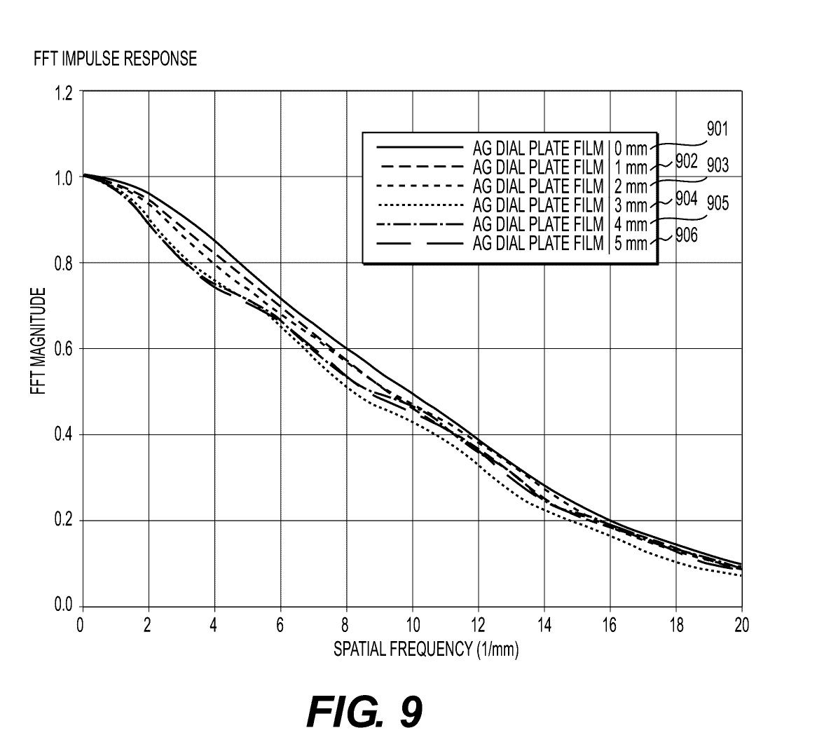

FIGS. 8 and 9 illustrate graphs 800/900 employed to determine an AG film implemented in both instrument clusters 200 and 400. The first graph 800 shows a Fast Fourier Transform (FFT) impulse responses of different distances of film from the display surface of a Bayer LM 296 Modulation Transfer Function (MTF) being implemented. In FIG. 8, distances of 0 mm to 4 mm (801-805) are plotted. The y-axis 810 is a MTF (FFT magnitude) while the x-axis 820 is the spatial frequency. The MTF is the FFT magnitude of the impulse function.

In contrast, in FIG. 9, graph 900 shows a similar y-axis 910 and an x-axis 920. The main difference in FIG. 9 is that distance from the display 0 mm-5 mm (901-906) of a second film is shown. As shown, in spatial frequencies above 6, the FFT magnitude does not collapse to zero (as shown in graph 800) and maintains an MTF that is large enough to provide image fidelity or clarity at an acceptable level. One of the key features of the second film shown in FIG. 9 is that the antiglare feature size is smaller than a TFT subpixel size.

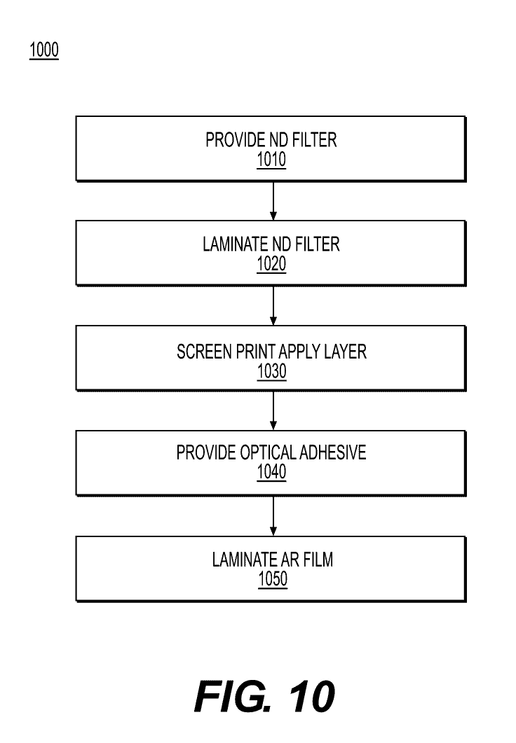

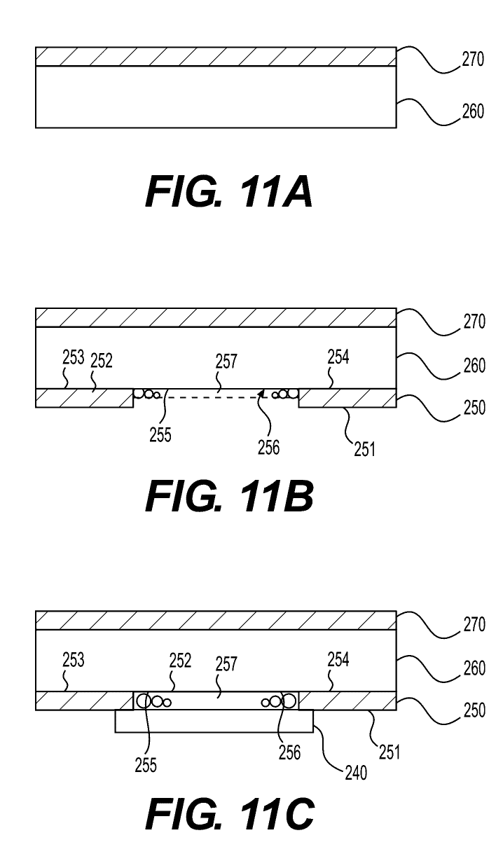

FIG. 10 illustrates a method 1000 for implementing a seamless instrument cluster. The method 1000 may be implemented to produce the instrument cluster 200 shown above. FIGS. 11(a)-(c) illustrate the resultant structure according to each operation of method 1000.

In operation 1010, a base neutral density (ND) filter is provided. The base ND filter should have the antiglare film already applied on the front side. The resultant structure is shown in FIG. 11(a). The ND filter may be part of a base film (i.e. integrated with an applique layer), or added separately. In the case where the ND filter is integrated with the applique film, the lamination step in operation 1020 may be avoided.

In operation 1020, if the ND filter is a clear base, the structure shown in FIG. 11(a) is laminated. In operation 1030, the applique layer is screen printed onto the back (i.e. the surface away from the viewer of instrument cluster 200) in a manner to include the fade pattern. The resultant structure is shown in FIG. 11(b).

In operation 1040, an optical adhesive may be affixed to the laminated smooth AR film 240. As explained above, the aperture 257 may be filled with the optical adhesive (liquid or pressure sensitive type). The smooth AR film 240 may be a Motheye film, for at least the reasons explained above. In operation 1050, a smooth AR film 240 is laminated over the display aperture 257, with the resultant structure in FIG. 11(c) being placed over a display 210 (with an AR film 220 provided). Thus, the display 200 shown in FIG. 2 may be realized.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

We claim:

1. An instrument cluster, comprising:
a display configured to project light in response to information provided via a digital display renderer;
a first antireflective (AR) film or coating applied onto a surface of the display;
an applique layer with an aperture to allow the projected light to a viewer of the instrument cluster; and
a second AR film applied to a surface of the applique layer that faces the display.

2. The instrument cluster of claim 1, further comprising an air gap between the first AR film and the second AR film.

3. The instrument cluster of claim 2, further comprising a neutral density (ND) filter provided on a surface of the applique layer or embedded in the applique substrate material via a dye.

4. The instrument cluster of claim 1, wherein the applique layer includes a fade pattern on a portion of the applique proximal to the aperture.

5. The instrument cluster of claim 4, wherein the fade pattern is provided via a half-sinusoidal pattern.

6. The instrument cluster of claim 3, wherein the applique layer includes a fade pattern on a portion of the applique proximal to the aperture.

7. The instrument cluster of claim 6, wherein the fade pattern is provided via a half-sinusoidal pattern.

8. The instrument cluster of claim 3, wherein the first or second AR film is a Motheye film.

9. The instrument cluster of claim 3, wherein the AG filter is defined by a filter with a property associated with a Modulation Transfer Function (MTF) over a predetermined threshold with a spacial frequency over a predetermined amount.

10. The instrument cluster of claim 3, wherein the ND filter is defined by a neutral density factor of 25% or greater.

11. An instrument cluster, comprising:
a display configured to project light in response to information provided via a digital display renderer;
an applique layer with an aperture to allow the projected light to a viewer of the instrument cluster; and
an AR film applied to a surface of the applique layer that faces the display,
wherein the display is provided with a smooth surface.

12. The instrument cluster of claim 11, further comprising an air gap between the AR layer on the applique layer and the AR layer on the display.

13. The instrument cluster of claim 12, further comprising a neutral density (ND) filter provided on a surface of the applique layer not facing the display.

14. The instrument cluster of claim 11, wherein the applique layer includes a fade pattern on a portion of the applique proximal to the aperture.

15. The instrument cluster of claim 14, wherein the fade pattern is provided via a half-sinusoidal pattern.

16. The instrument cluster of claim 13, wherein the applique layer includes a fade pattern on a portion of the applique proximal to the aperture.

17. The instrument cluster of claim 16, wherein the fade pattern is provided via a half-sinusoidal pattern.

18. The instrument cluster of claim 13, wherein the AR film is of a smooth-type.

19. The instrument cluster of claim 13, wherein the AG filter is defined by a filter with a property associated with a Modulation Transfer Function (MTF) over a predetermined threshold with a spatial frequency of 6 or greater.

20. The instrument cluster of claim 13, wherein the ND filter is defined by a neutral density factor of 25% or greater.
